(19) United States
(12) Patent Application Publication
(10) Pub. No.: US 2020/0173281 A1
(43) Pub. Date: Jun. 4, 2020

(54) ROCK BOLT WITH RELEASEABLY FIXABLE BUNG

(71) Applicant: EPIROC HOLDINGS SOUTH AFRICA (PTY) LTD., Johannesburg (ZA)

(72) Inventor: Brendan Robert CROMPTON, Johannesburg (ZA)

(21) Appl. No.: 16/615,176

(22) PCT Filed: May 30, 2018
(86) PCT No.: PCT/ZA2018/050028

§ 371 Date: Nov. 20, 2019

(30) Foreign Application Priority Data
May 30, 2017 (ZA) 2017/03689

(51) Int. Cl. E21D 20/02; E21D 21/00; F16J 15/02

(52) U.S. Cl. CPC E21D 20/026; F16J 15/022; E21D 21/0093

(57) ABSTRACT

A bung has a body which extends between a leading end and a trailing end and which includes an inner part of a rigid material which has a cylindrical aperture for receiving a rock bolt and an outer sealing part of a resiliently deformable material circumscribing the inner part. The inner part and the outer part engage at an interface which has a co-efficient of friction which allows the outer part to disengage from the inner part at the interface when a shear force above a predetermined level is applied to the outer part or the inner part.

### BACKGROUND OF THE INVENTION

This invention relates to a stopper, bung or seal for use with a grouted rock bolt and to an improved method of stabilizing a rock mass with a rock bolt and cartridge grouted application.

Use of a bung, with a grouted rock bolt installation, is known. However, in such an installation, the grout is pumped into the rock hole after the rock bolt is installed via a grout pipe. Spinning of the rock bolt is not required or necessary in such an installation. The bung is adapted to receive the grout tube, the rock bolt and a breather pipe, as it seals the mouth of the hole to grout egress.

A problem occurs when grout is introduced into the rock hole, contained in capsules that are pre-inserted, ahead of the rock bolt. In this type of installation, the rock bolt is used to first puncture the capsules, to release the resin or grout, and then the bolt is spun to disperse and mix the grout.

The spinning of the bolt prevents the use of a bung, located on the bolt to sealingly engage with the mouth of the rock hole to prevent grout egress.

The invention aims, at least partly, to address the aforementioned problems.

### SUMMARY OF THE INVENTION

In a first aspect, the invention provides a bung which has a body which extends between a leading end and a trailing end and which includes an inner part of a rigid material which has a cylindrical aperture for receiving a rock bolt and an outer sealing part of a resiliently deformable material circumscribing the inner part, wherein the inner part and the outer part engage at an interface which has a co-efficient of friction which allows the outer part to disengage from the inner part at the interface when a shear force above a predetermined level is applied to the outer part or the inner part.

The invention further provides a bung which has a body which extends between a leading end and a trailing end and which includes an inner part of rigid material, which has a cylindrical aperture for receiving a rock bolt, and an outer sealing part of a resiliently deformable material circumscribing the inner part wherein the inner part and the outer part engage at an interface and wherein, when a shear force applied to the outer part or inner part is above a predetermined level, the outer part disengages from the inner part at the interface.

An outer wall of the outer part may be formed with sealing formations.

The sealing formations may be a plurality of circumferential sealing ridges or ribs.

The outer wall may include an abutment formation at or towards the trailing edge which is adapted to abut against a mouth of rock hole in use.

The rock bolt may be fixedly engaged to the cylindrical aperture of the inner part.

The wall of the cylindrical aperture may be threaded to threadedly engage counterpart threads on the rock bolt. Alternatively, the wall of the cylindrical aperture may be adhered to the rock bolt with a suitable adhesive or frictionally engaged with the rock bolt.

In a second aspect, the invention provides an improved method of grouting a rock bolt in a rock hole which includes a step of sealing the rock hole at a proximal position with a bung which is engaged with the rock bolt at a position which remains fixed when an insertion force applied to the rock bolt does not exceed a level which allows for the bung to sealingly engage the rock hole at the proximal position, but which disengages from the position in whole or in part, when the force exceeds the level, allowing the rock bolt to move axially relatively to the bung to advance into the hole to rupture a pre-inserted capsule and allowing the bolt to be spun about its axis.

The proximal position may be a mouth of the rock hole.

The rock bolt may have a formation onto which the bung attaches, and detaches when the insertion force exceeds the level.

Alternatively, the bung may have a two-part body comprised of an inner part that fixedly attaches to the rock bolt and an outer sealing part over the inner part that detaches from the inner part when the insertion force exceeds the level.

The method may include a prior step, before sealing the rock hole at the proximal position, of sealing the rock hole at a distal position by insertion of a cup or hollow conical shaped sealing device.

The grout capsule may be engaged within a cavity of sealing device.

The sealing device may be inserted into the rock hole apex end leading, with the grout capsule trailing.

The distal position may be predetermined by the length of the rock hole relatively to the rock bolt.

### BRIEF DESCRIPTION OF THE DRAWINGS

The invention is further described by way of example with reference to the accompanying drawings in which:

FIG. 1 is a view in elevation of a bung in accordance with a first aspect of the invention;

FIG. 2 is a view in longitudinal section, through line 2-2′, of FIG. 1;

FIG. 3 is an isometric view of the bung of FIG. 1; and

FIGS. 4 to 7 diagrammatically and sequentially illustrate a method of using the bung in accordance with a method of the invention.

### DESCRIPTION OF THE PREFERRED EMBODIMENT

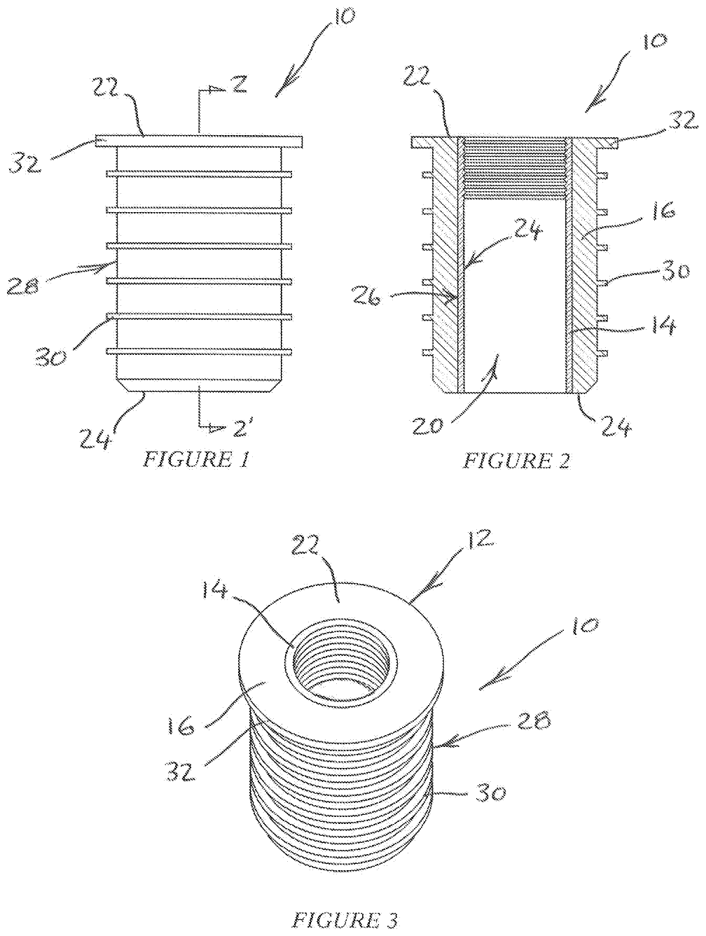

The invention provides, in a first aspect, a bung 10. The bung is illustrated in FIGS. 1 to 3. The bung includes, in this particular embodiment, a cylindrical body 12 which comprises of an inner part 14 made of a rigid material, and a circumscribing outer part 16. The outer part is made of a resiliently deformable material. The inner part 14 is cylindrically tubular, having a cylindrical aperture 20 which passes through the body 12 from a first end 22 to a second end 24. It is through this circular cylindrical aperture that a rock bolt, in use, passes as will be described more fully below. The inner part is a thin walled component defined between an inner and an outer surface, 24 and 26 respectively. At the outer surface, the inner part sealingly interfaces with the outer part 16.

An outer exterior 28 of the outer part 16 is formed with a plurality of evenly spaced circumscribing sealing formations 30 and, at the second end 22, a circumferentially larger flanged annular abutment formation 32.

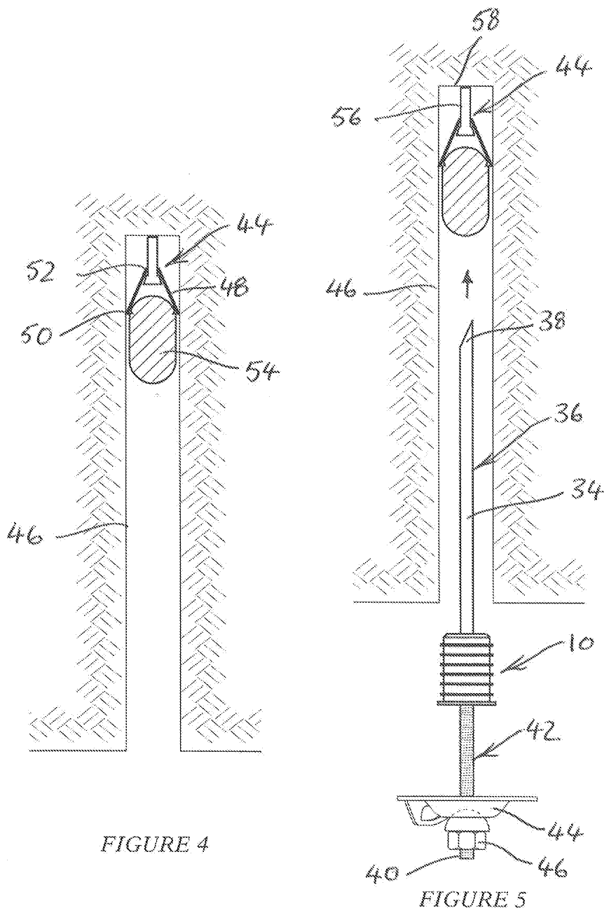

FIGS. 4 to 7 sequentially illustrate a second aspect of the invention being a method of grouting a rock hole with a rock bolt using the bung 10 of the first aspect of the invention.

In the method, a rock bolt 34 is provided which includes an elongate body 36 which extends between a distal end 38 and a proximal end 40. On a threaded proximal end portion 42, the rock bolt carries a face plate 44 and a trailing nut 46 which is threadedly engaged to the threaded portion.

The bolt body 36 is passed through the cylindrical aperture 20 of the bung 10 and, at a pre-set position, fixedly engaged to the position. The bung can be fixed onto the rock bolt by any suitable means such as, for example, by adhering the inner part's inner surface 24 to the rock bolt. However, in this particular embodiment, the inner surface 24 is at least partially threaded from the first end 22 to engage with the threads of the bolt's threaded section 42.

In another embodiment, not illustrated here, the bung 10 may be fixedly engaged at the pre-set location by wedging into with a suitable formation on the rock bolt, for example on a paddle formation.

In a first step, a resin cartridge positioner 44 is inserted into a rock hole 46. The positioner has a hollow cup-like or conical body 48 which tapers from a mouth 50 to an apex end 52. The cup-like body is resiliently deformable and radially deforms to resistively hold a grout cartridge 54 which is pre-inserted into the mouth and held there. The positioner holds the cartridge suspended from its mouth, towards an opening of the rock hole.

A spacer 56 can be used, engaged with the positioner body 48, to space the positioner at a predetermined distance from a blind end 58 of the hole 46.

At the location at which the cartridge positioner 44 locates within the hole 46, a distal grout column seal is defined. The grout column seal is formed by the sealing engagement of an outer surface of the cup-like body against the walls of the rock hole. At the distal seal, an upper end partition 60 of the rock hole 46 is sealed from a grout column partition 62.

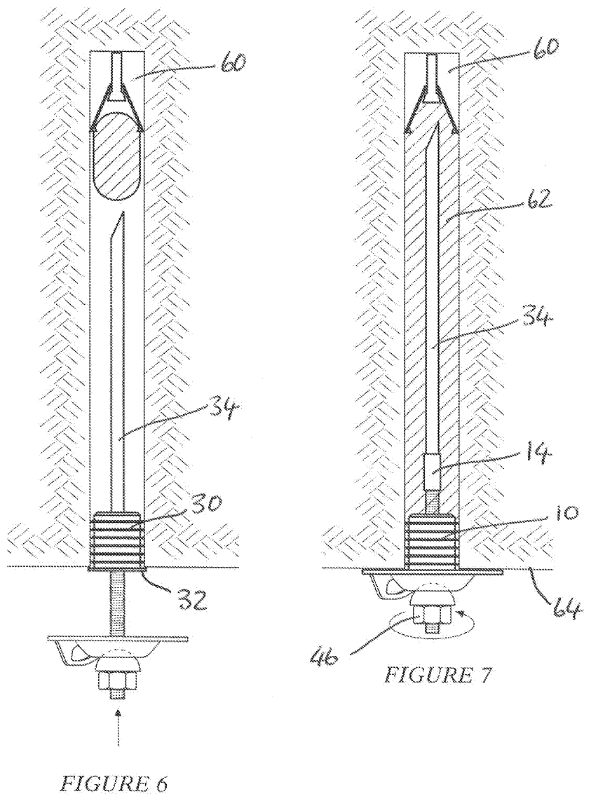

In a follow-up step, the rock bolt 34 is inserted into the rock hole 46, distal end 38 leading. This is illustrated in FIG. 5. The distal end 38 of the rock bolt is pointed.

As illustrated in FIG. 6, the rock bolt partially inserts into the rock hole before the bung 10 comes into sealing contact with the mouth of the rock hole to provide a proximal grout column seal. The sealing effect of the bung is enhanced by the resiliently deformable material of the outer part 16 and the sealing formations 30. The bung inserts into the hole until the annular abutment formation 32 abuts a perimeter of the opening.

In a final step, with further force applied axially to the rock bolt, the inner part 14 of the bung 10 disengages from the outer part 16 at the outer surface 26 allowing the bolt to penetrate deeper into the hole. As illustrated in FIG. 7, this axial movement brings the faceplate 44 into contact with the hanging wall 64. At the same time the pointed first end 38 of the rock bolt penetrates the grout cartridge which releases its grout content.

The rock bolt 34 can be spun by engaging the chuck of a bolter (not shown) to the nut 46 to mix and distribute the grout. This action also tightens the nut 46 against the faceplate 44.

With the rock hole 46 distally sealed, by the grout cartridge positioner 52, and proximally sealed, by the bung 10, the grout is contained within the grout column partition 62 of the rock bolt.

Confining the grout to this partition maximises the grouted adherence of the rock bolt to the rock hole with the available grout. Grout is not wasted, unused in the upper end partition 60, or leaking from the rock hole opening.

1. A bung which has a body which extends between a leading end and a trailing end and which includes an inner part of rigid material, which has a cylindrical aperture for receiving a rock bolt, and an outer sealing part of a resiliently deformable material circumscribing the inner part wherein the inner part and the outer part engage at an interface and wherein, when a shear force applied to the outer part or inner part is above a predetermined level, the outer part disengages from the inner part at the interface.

2. A bung according to claim 1 wherein an outer wall of the outer part is formed with sealing formations.

3. A bung according to claim 2 wherein the sealing formations are a plurality of circumferential sealing ridges or ribs.

4. A bung according to claim 2 wherein the outer wall includes an abutment formation at or towards the trailing edge.

5. A bung according to claim 1, wherein the rock bolt is fixedly engaged to the cylindrical aperture of the inner part.

6. A bung according to claim 5 wherein a wall of the cylindrical aperture is threaded to threadedly engage counterpart threads on the rock bolt.

7. A bung according to claim 5 wherein the rock bolt is adhered to, or frictionally engaged with, the cylindrical aperture.

8. A method of grouting a rock bolt in a rock hole which includes a step of sealing the rock hole at a proximal position with a bung which is engaged with the rock bolt at a position which remains fixed when an insertion force applied to the rock bolt does not exceed a level which allows for the bung to sealingly engage the rock hole at the proximal position, but which disengages from the position, in whole or in part, when the force exceeds the level, allowing the rock bolt to move axially relatively to the bung to advance into the hole to rupture a pre-inserted capsule and allowing the bolt to be spun about its axis.

9. A method according to claim 8 wherein the proximal position is a mouth of the rock hole.

10. A method according to claim 8 wherein the rock bolt has a formation onto which the bung attaches at the position and detaches when the insertion force exceeds the level.

11. A method according to claim 8 wherein the bung has a two-part body comprised of an inner part that fixedly attaches to the rock bolt at the position and an outer sealing part over the inner part that detaches from the inner part when the insertion force exceeds the level.

12. A method according to claim 8 which include a step prior to sealing the rock hole at the proximal position, of sealing the rock hole at a distal position by insertion of a cup or hollow conical shaped sealing device.

13. A method according to claim 12 wherein the grout capsule is engaged with the sealing device between the distal position and the proximal position.

14. A bung according to claim 3, wherein the outer wall includes an abutment formation at or towards the trailing edge.

15. A bung according to claim 2, wherein the rock bolt is fixedly engaged to the cylindrical aperture of the inner part.

16. A bung according to claim 3, wherein the rock bolt is fixedly engaged to the cylindrical aperture of the inner part.

17. A bung according to claim 4, wherein the rock bolt is fixedly engaged to the cylindrical aperture of the inner part.

18. A method according to claim 9 wherein the rock bolt has a formation onto which the bung attaches at the position and detaches when the insertion force exceeds the level.

19. A method according to claim 9 wherein the bung has a two-part body comprised of an inner part that fixedly attaches to the rock bolt at the position and an outer sealing part over the inner part that detaches from the inner part when the insertion force exceeds the level.

20. A method according to claim 9 which include a step prior to sealing the rock hole at the proximal position, of sealing the rock hole at a distal position by insertion of a cup or hollow conical shaped sealing device.
